(19) United States
(12) Patent Application Publication
(10) Pub. No.: US 2009/0101388 A1
(43) Pub. Date: Apr. 23, 2009

(54) FLAT CABLE ASSEMBLY FOR USE IN POWER SUPPLY APPARATUS

(75) Inventors: Hung-Chuan Chen, Taoyuan (TW); Ming-Hsien Hsieh, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/035,514

(22) Filed: Feb. 22, 2008

(30) Foreign Application Priority Data
Oct. 19, 2007 (TW) 096139343

(51) Int. Cl. H01B 7/08; H01R 13/58

(52) U.S. Cl. 174/117 FF; 439/473

(57) ABSTRACT

A flat cable assembly includes a plurality of power cables and a bonding medium. The plurality of power cables are parallel with each other, wherein every two adjacent power cables are separated from each other. The bonding medium is used for boding every two adjacent power cables together, thereby cooperatively forming the flat cable assembly having a first surface and a second surface. A first gap is formed between the first surface and the bonding medium and a second gap is formed between the second surface and the bonding medium.

### FIELD OF THE INVENTION

The present invention relates to a flat cable assembly, and more particularly to a flat cable assembly for use in a power supply apparatus.

### BACKGROUND OF THE INVENTION

Power supply apparatuses are essential for many electronic appliances such as personal computers, industrial computers, servers, communication products or network products. Usually, the user may simply plug a power supply apparatus into an AC wall outlet commonly found in most homes or offices so as to receive an AC voltage. The power supply apparatus will convert the AC voltage into a regulated DC output voltage for powering the electronic device such as a computer host.

Referring to FIG. 1, a schematic partial perspective view of a conventional power supply apparatus is illustrated. The power supply apparatus 10 is applied to for example a computer host and principally includes a casing 11, a power cable assembly including a plurality of power cables 13, and a plurality of connectors 14. A circuit board (not shown) is disposed inside the casing 11 for converting and stabilizing voltages. These power cables 13 are extended externally from the circuit board through an outlet 12. The terminals of the power cables 13 are coupled to respective connectors 14 according to the designed specifications. The connectors 14 will be inserted into corresponding sockets of the computer so as to provide regulated DC output voltages required for specified components of the computer host, e.g. a motherboard, a hard disk, an optical disk drive and the like.

The conventional power supply apparatus 10, however, still has some drawbacks. Since a great number of power cables 13 are penetrated through the outlet 12 of the casing 11 of the power supply apparatus 10, these power cables 13 are separated from each other in a mess and thus easily entangled. The entangled power cables 13 may fully occupy the inner space of the host computer's housing. Under this circumstance, the efficacy of air convection inside the computer host's housing is impaired and the heat dissipating efficiency is reduced.

For solving the above drawbacks, a ribbon or a flexible mesh is used to hold the power cables 13 connected to individual connector 14 in a bundle. As known, the ribbon is readily lost or loosened. In addition, the flexible mesh is not cost-effective.

Moreover, each power cable 13 is connected to a corresponding position of the connector 14. If a mismatch of the power cable 13 and the connector 14 occurs, the regulated DC output voltage fails to be transmitted to the required component of the computer host. Since the plentiful power cables 13 are separated from each other in a mess, it is difficult to assure whether these power cables 13 are accurately connected to the right positions of corresponding connectors 14. As a consequence, the possibility of erroneously inserting the power cables 13 into respective connectors 14 is increased and the assembling process is troublesome.

In views of the above-described disadvantages resulted from the prior art, the applicant keeps on carving unflaggingly to develop a flat cable assembly for use in a power supply apparatus.

### SUMMARY OF THE INVENTION

It is an object of the present invention to provide a flat cable assembly for use in a power supply apparatus. Since no ribbon or flexible mesh is used, the drawbacks resulted from the prior art are alleviated.

Another object of the present invention provides a flat cable assembly for use in a power supply apparatus so as to avoid erroneously inserting the power cables into respective connectors.

In accordance with an aspect of the present invention, there is provided a flat cable assembly for use in a power supply apparatus. The flat cable assembly includes a plurality of power cables and a bonding medium. The plurality of power cables are parallel with each other, wherein every two adjacent power cables are separated from each other. The bonding medium is used for boding every two adjacent power cables together, thereby cooperatively forming the flat cable assembly having a first surface and a second surface. A first gap is formed between the first surface and the bonding medium and a second gap is formed between the second surface and the bonding medium.

In an embodiment, the bonding medium is an adhesive.

Preferably, the adhesive is a polyvinyl chloride (PVC) adhesive.

In an embodiment, each of the power cables includes a conductive core and an insulating cover. The insulating cover is sheathed around the conductive core for insulating the conductive core. The conductive cores of the power cables are aligned in one or more rows.

In an embodiment, the conductive cores of the power cables are aligned in a single row.

In an embodiment, the conductive cores of the power cables are aligned in two rows.

In an embodiment, the power cables have the same dimension.

In an embodiment, the power cables include at least two different dimensions.

In accordance with another aspect of the present invention, there is provided a power supply apparatus. The power supply apparatus includes a casing, a flat cable assembly and at least one first connector. The flat cable assembly has a terminal electrically connected to a circuit board inside the casing. The flat cable assembly includes a plurality of power cables parallel with each other and a bonding medium for boding every two adjacent power cables together, thereby cooperatively forming the flat cable assembly having a first surface and a second surface. A first gap is formed between the first surface and the bonding medium and a second gap is formed between the second surface and the bonding medium. The first connector is coupled with a second terminal of the flat cable assembly.

In an embodiment, the power cables are connected to the circuit board through an outlet of the casing.

In an embodiment, the power supply apparatus further includes a power socket mounted on an external surface of the casing and electrically connected to the circuit board.

In an embodiment, a second connector is arranged on the first terminal of the flat cable assembly and inserted into the power socket.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic partial perspective view of a conventional power supply apparatus;

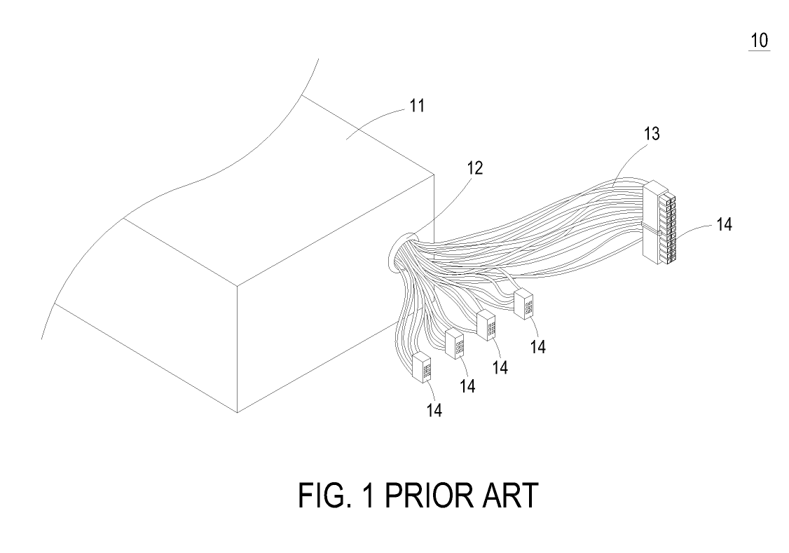

FIGS. 2A, 2B and 2C are schematic cross-sectional views illustrating three exemplary flat cable assemblies of the present invention;

FIG. 3 is a schematic partial perspective view illustrating the flat cable assembly for use in a power supply apparatus according to a preferred embodiment of the present invention; and

FIG. 4 is a schematic partial perspective view illustrating the flat cable assembly for use in a power supply apparatus according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

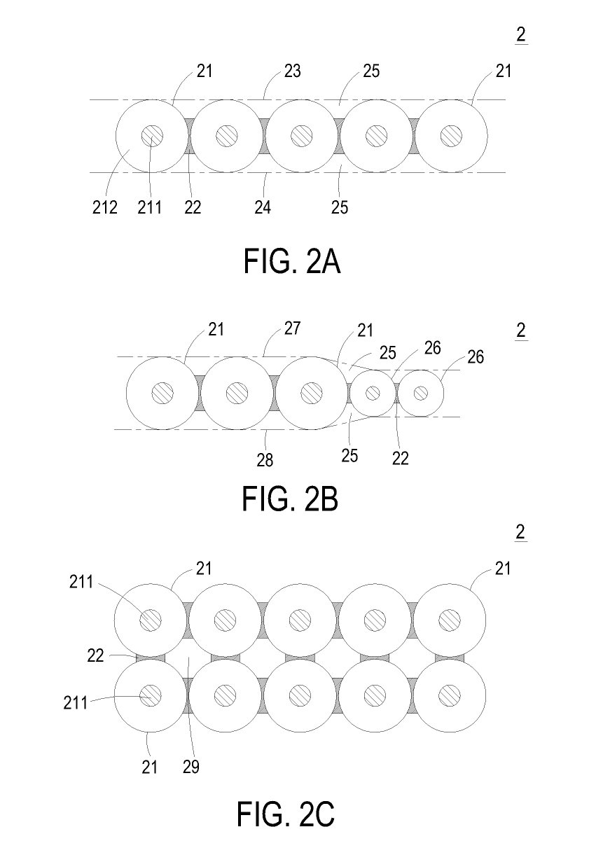

FIG. 2A is a schematic cross-sectional view illustrating an exemplary flat cable assembly of the present invention. The flat cable assembly 2 is applied to an electric appliance such as a power supply apparatus. The flat cable assembly 2 principally includes a plurality of power cables 21 and a bonding medium 22. Each power cable 21 includes a conductive core 211 and an insulating cover 212. The insulating cover 212 is sheathed around the conductive core 211 for insulating the conductive core 211. The conductive cores 211 of these power cables 21 are substantially parallel with each other and aligned in a single row. Every two adjacent power cables 21 are separated from each other but bonded together via the bonding medium 22. The bonding medium 22 is an adhesive such as a polyvinyl chloride (PVC) adhesive. Via the bonding medium 22, the plurality of power cables 21 are cooperatively formed as the flat cable assembly 2. As shown in FIG. 2A, these power cables 21 have a common first surface 23 and a common second surface 24. There is a gap 25 formed between the top surface of the bonding medium 22 and the first surface 23. Likewise, there is another gap 25 formed between the bottom surface of the bonding medium 22 and the second surface 24.

In the embodiment of FIG. 2A, the power cables 21 of the flat cable assembly 2 have identical dimensions. It is noted that, however, those skilled in the art will readily observe that numerous modifications and alterations may be made while retaining the teachings of the invention. For example, as shown in FIG. 2B, the flat cable assembly 2 includes a plurality of first-sized power cables 21 and a plurality of second-sized power cables 26. The cores of the power cables 21 and the cores of the power cables 26 are substantially parallel with each other and aligned in a single row. Every two adjacent power cables 21 or 26 are separated from each other but bonded together via the bonding medium 22. Via the bonding medium 22, the plurality of power cables 21 are cooperatively formed as the flat cable assembly 2. As shown in FIG. 2B, these power cables 21 and 26 have a common first surface 27 and a common second surface 28. There is a gap 25 formed between the top surface of the bonding medium 22 and the first surface 27. Likewise, there is another gap 25 formed between the bottom surface of the bonding medium 22 and the second surface 28.

For complying with different specifications of the specified components of the computer host, the configurations of the connectors of the power supply apparatus are varied so that the flat cable assembly coupled to the respective connector are also varied. For example, as shown in FIG. 2C, the flat cable assembly 2 includes a plurality of power cables 21 arranged in two rows and a bonding medium 22. The flat cable assembly 2 of FIG. 2C may be coupled with a connector, such as a SATA connector, for further being coupled to a socket of a mother board, a socket of a hard disc driver or a connector of a high-power video card of the computer host. The cores 211 of the power cables 21 are substantially parallel with each other and aligned in a first row and a second row. In the vertical direction, the cores 211 of the power cables 21 are also aligned with each other. Every two adjacent power cables 21 are separated from each other but bonded together via the bonding medium 22. In addition, a vacant space 29 is formed between every four adjacent power cables 21. Via the bonding medium 22, the plurality of power cables 21 are cooperatively formed as the two-row flat cable assembly 2.

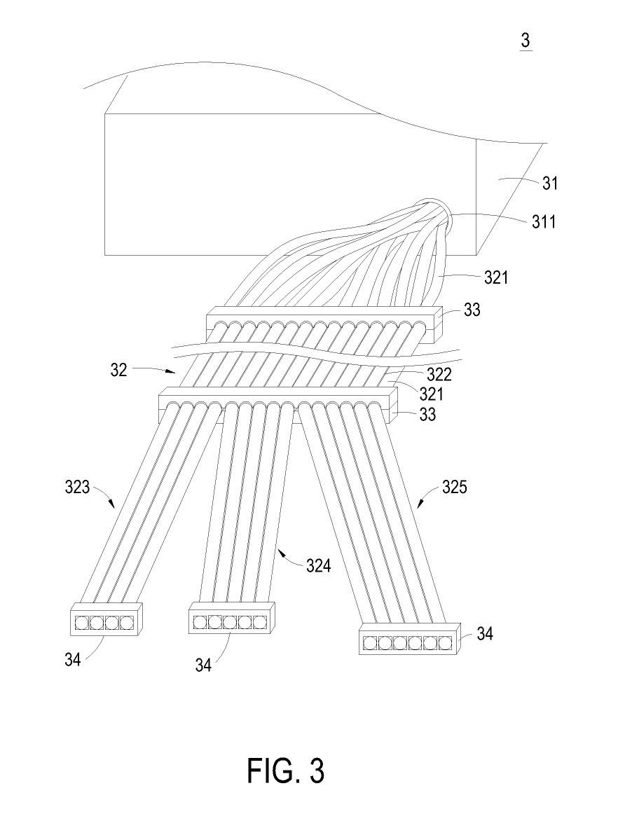

FIG. 3 is a schematic partial perspective view illustrating the flat cable assembly for use in a power supply apparatus according to a preferred embodiment of the present invention. The power supply apparatus 3 is applied to for example a computer host and principally includes a casing 31, a plurality of power cables 321, a confining member 33 and a plurality of connectors 34. A circuit board (not shown) is disposed inside the casing 31 for converting and stabilizing voltages. The first terminals of these power cables 321 are dispersed and extended externally from the circuit board through an outlet 311 of the casing 31. According to the method mentioned in FIG. 2A, at least the middle portions of these power cables 321 are formed as a flat cable assembly 32 by means of a bonding medium 322. The second terminals of the power cables 321 are coupled to respective connectors 34 according to the designed specifications.

Alternatively, the flat cable assembly 32 may be divided into several flat cable sub-assemblies 323, 324 and 325. The number of the sub-assemblies may be varied as required. These flat cable sub-assemblies 323, 324 and 325 are coupled to corresponding connectors 34 according to the designed specifications.

In some embodiments, at least one confining member 33 is disposed in the middle portion of the flat cable assembly 32 for confining the flat cable assembly 32 and preventing separation of the power cables 321.

Since the plurality of power cables 321 are bonded together via the bonding medium 322 to form as the flat cable assembly 32, the possibility of erroneously inserting the power cables 321 into respective connectors 34 is minimized. In addition, it is easy to insert the power cables 321 into respective connectors 34. In some embodiments, the insulating covers of the power cables 321 are coated with different colors, thereby facilitating insertion of the power cables 321 into respective connectors 34.

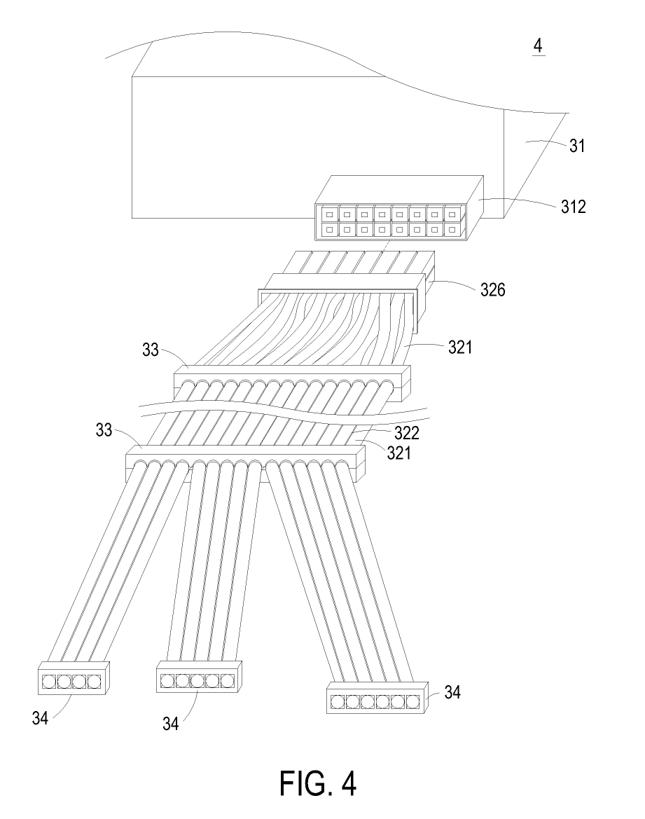

FIG. 4 is a schematic partial perspective view illustrating the flat cable assembly for use in a power supply apparatus according to another preferred embodiment of the present invention. The power supply apparatus 4 is applied to for example a computer host. In this embodiment, the casing 31, the power cables 321, the confining member 33 and the connectors 34 included therein are similar to those shown in FIG. 3, and are not redundantly described herein. In addition, the power supply apparatus 4 further has a power socket 312 mounted on an external surface of the casing 31 and electrically connected to the circuit board (not shown). The first terminals of these power cables 321, which are dispersed, are coupled to a second connector 326. After the second connector 326 is inserted into the power socket 312 of the power supply apparatus 4, the computer host is electrically connected with the circuit board inside the casing 31 of the power supply apparatus 4 through the power cables 321, the second connector 326 and the power socket 312.

From the above description, the flat cable assembly of the present invention is formed by bonding every two adjacent power cables together with the bonding medium. Since the conductive cores of these power cables are substantially parallel with each other and aligned in one or more rows, the power cables are inserted into respective connectors without difficulty and error.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A flat cable assembly for use in a power supply apparatus, said flat cable assembly comprising:
a plurality of power cables parallel with each other, wherein every two adjacent power cables are separated from each other; and
a bonding medium for boding every two adjacent power cables together, thereby cooperatively forming said flat cable assembly having a first surface and a second surface, wherein a first gap is formed between said first surface and said bonding medium and a second gap is formed between said second surface and said bonding medium.

2. The flat cable assembly according to claim 1 wherein said bonding medium is an adhesive.

3. The flat cable assembly according to claim 2 wherein said adhesive is a polyvinyl chloride adhesive.

4. The flat cable assembly according to claim 1 wherein each of said power cables include:
a conductive core; and
an insulating cover sheathed around said conductive core for insulating said conductive core, wherein said conductive cores of said power cables are aligned in one or more rows.

5. The flat cable assembly according to claim 4 wherein said conductive cores of said power cables are aligned in a single row.

6. The flat cable assembly according to claim 4 wherein said conductive cores of said power cables are aligned in two rows.

7. The flat cable assembly according to claim 1 wherein said power cables have the same dimension.

8. The flat cable assembly according to claim 1 wherein said power cables include at least two different dimensions.

9. A power supply apparatus comprising:
a casing;
a flat cable assembly having a first terminal electrically connected to a circuit board inside said casing and including a plurality of power cables parallel with each other and a bonding medium for boding every two adjacent power cables together, thereby cooperatively forming said flat cable assembly having a first surface and a second surface, wherein a first gap is formed between said first surface and said bonding medium and a second gap is formed between said second surface and said bonding medium; and
at least one first connector coupled with a second terminal of said flat cable assembly.

10. The power supply apparatus according to claim 9 wherein said bonding medium is an adhesive.

11. The power supply apparatus according to claim 10 wherein said adhesive is a polyvinyl chloride adhesive.

12. The power supply apparatus according to claim 9 wherein said power cables are connected to said circuit board through an outlet of said casing.

13. The power supply apparatus according to claim 9 further including a power socket mounted on an external surface of said casing and electrically connected to said circuit board.

14. The power supply apparatus according to claim 13 wherein a second connector is arranged on said first terminal of said flat cable assembly and inserted into said power socket.

15. The power supply apparatus according to claim 9 further including at least one confining member for confining said flat cable assembly and preventing separation of said power cables.

16. The power supply apparatus according to claim 9 wherein each of said power cables include:
a conductive core; and
an insulating cover sheathed around said conductive core for insulating said conductive core, wherein said conductive cores of said power cables are aligned in one or more rows.

17. The power supply apparatus according to claim 16 wherein said conductive cores of said power cables are aligned in a single row.

18. The power supply apparatus according to claim 16 wherein said conductive cores of said power cables are aligned in two rows.

19. The power supply apparatus according to claim 9 wherein said power cables have the same dimension.

20. The power supply apparatus according to claim 9 wherein said power cables include at least two different dimensions.
